(19) United States
(12) Patent Application Publication
(10) Pub. No.: US 2003/0108365 A1
(43) Pub. Date: Jun. 12, 2003

(54) Image forming apparatus

(75) Inventor: Takahito Kabai, Yokohama-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/003,254

(22) Filed: Dec. 6, 2001

(51) Int. Cl. G03G 15/16; G03G 21/00

(52) U.S. Cl. 399/297; 399/358; 399/359

(57) ABSTRACT

Disclosed is an image forming apparatus comprising an intermediate transfer belt onto which the toner image formed on a photosensitive drum by a developing device is temporarily transferred, a drum cleaner for removing the residual toner remaining on the photosensitive drum after transfer of the toner image onto the intermediate transfer belt, a transfer roller for transferring the toner image transferred onto the intermediate transfer belt onto a paper sheet, a belt cleaner for removing the residual toner remaining on the intermediate transfer belt after transfer of the toner image performed by the transfer roller, a first recovery device for recovering the toner removed by the drum cleaner in the developing device, and a second recovery device for recovering the toner removed by the belt cleaner in a recovery container.

### BACKGROUND OF THE INVENTION

The present invention relates to an image forming apparatus used as, for example, an electrophotographic copying machine.

In an image forming apparatus of this type, a photosensitive drum is irradiated with laser light in conformity with image information so as to form an electrostatic latent image. Then, toner is supplied from a developing device onto the electrostatic latent image formed on the surface of the photosensitive drum so as to form a toner image. The toner image thus formed is transferred onto a recording material such as a paper sheet. After transfer of the toner image, the toner remaining on the surface of the photosensitive drum is removed and recovered by a cleaning device.

There is an image forming apparatus of this type that employs a so-called “waste toner recycle system” , in which the toner recovered by the cleaning device is supplied again to the developing device so as to utilize the recovered toner. Employment of this system makes it possible to eliminate the production of waste toner so as to provide a cheap printed image.

However, various kinds of foreign matter become attached to the surface of the photosensitive drum via the recording material, with the result that this foreign matter is also introduced into the developing device together with the waste toner. It follows that material such as paper fibers impairs the formation of the developing layer so as to bring about a defective image in the developing step. Also, an additive to the paper such as talc impairs the charging properties of the developing agent so as to shorten the life of the developing device and the life of the developing agent.

Also, in recent years, recycled paper has come into wide use to in response to environmental problems. It should be noted that it is possible for various kinds of foreign matter to be contained in the recycled paper so as to further shorten the life of the developing device and the life of the developing agent.

### BRIEF SUMMARY OF THE INVENTION

An object of the present invention, which has been achieved in view of the situation described above, is to provide an image forming apparatus capable of preventing the life of the developing device and the life of the developing agent from being shortened even if the recovered waste developing agent is introduced into the developing device for reuse.

According to a first aspect of the present invention, there is provided an image forming apparatus, comprising an image forming device which forms an electrostatic latent image on an image carrier; a developing device which supplies a developing agent onto the electrostatic latent image formed by the image forming device so as to form a developing agent image; an intermediate transfer body onto which the developing agent image formed by the developing device is temporarily transferred; a first removing device which removes the developing agent remaining on the image carrier after transfer of the developing agent image onto the intermediate transfer body; a transfer device which transfers the developing agent image transferred onto the intermediate transfer body onto a recording material; a second removing device which removes as a waste developing agent the developing agent remaining on the intermediate transfer body after transfer of the developing agent image performed by the transfer device; a first recovery device which recovers the developing agent removed by the first removing means into the developing device; and a second recovery device which recovers the developing agent removed by the second removing device into a recovery section.

According to a second aspect of the present invention, there is provided an image forming apparatus, comprising a plurality of image forming devices which form a plurality of electrostatic latent images on a plurality of image carriers; a plurality of developing devices which supply developing agents of different colors onto the electrostatic latent images formed by the image forming devices so as to form developing agent images; an intermediate transfer body onto which the developing agent images formed by the developing devices are temporarily transferred in a superposed fashion; a plurality of first removing devices which remove the developing agent remaining on each of the image carriers after transfer of the developing agent image onto the intermediate transfer body; a transfer device which transfers the developing agent image transferred onto the intermediate transfer body onto a recording material; a second removing device which removes as a waste developing agent the developing agent remaining on the intermediate transfer body after transfer of the developing agent image performed by the transfer device; a first recovery device which recovers the developing agent removed by the plural first removing devices into the plural developing devices; and a second recovery device which recovers the developing agent removed by the second removing device into a recovery section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the present invention.

FIG. 1 shows the inner construction of an electrophotographic copying apparatus according to a first embodiment of the present invention;

FIG. 2 shows the construction of a recovery mechanism of waste toner; and

FIG. 3 shows the inner construction of a color electrophotographic copying apparatus according to a second embodiment of the present invention.

### DETAILED DESCRIPTION OF THE INVENTION

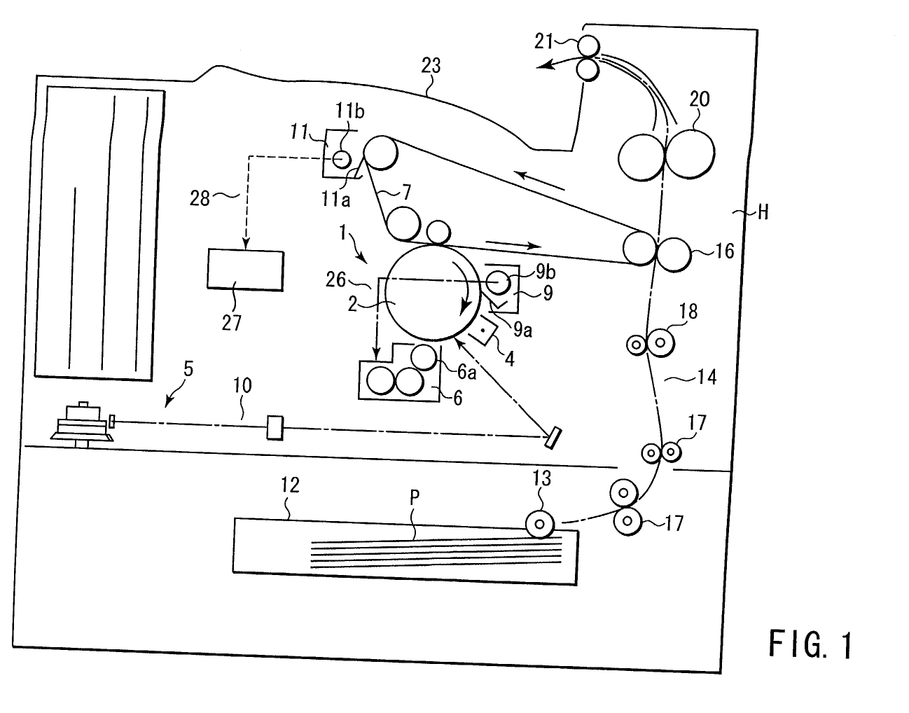

FIG. 1 shows the inner construction of an electrophotographic copying apparatus as an image forming apparatus according to a first embodiment of the present invention.

As shown in the drawing, the electrophotographic copying apparatus of the present invention comprises an apparatus body H in which is formed an image forming section 1. The image forming section 1 includes a photosensitive drum 2 acting as a rotatable image carrier. Arranged in the peripheral portion of the photosensitive drum 2 are a charging device 4, a developing device 6, an intermediate transfer belt 7 acting as an intermediate transfer body, and a drum cleaner 9 acting as a first removing device in the order mentioned in the rotating direction of the photosensitive drum 2 denoted by an arrow.

The charging device 4 serves to charge the surface of the photosensitive drum 2 to a predetermined potential. The developing device 6 includes a developing roller 6a. Toner is supplied by the developing roller 6a onto the electrostatic latent image formed on the surface of the photosensitive drum 2 so as to form a visible toner image. The intermediate transfer belt 7 serves to temporarily transfer the toner image formed on the photosensitive drum 2. Further, the drum cleaner 9 includes a blade 9a and a discharge auger 9b. The toner image remaining on the photosensitive drum 2 is removed by the blade 9a.

A belt cleaner 11 acting as a second removing device serving to remove the residual toner on the intermediate transfer belt 7 is arranged in the vicinity of the intermediate transfer belt 7. The belt cleaner 11 includes a blade 11a abutting the transfer belt 7 and a transfer auger 11b for transferring the toner scraped off by the blade 11a.

A laser light exposure device 5 acting as an image forming device for forming an electrostatic latent image on the surface of the photosensitive drum 2 is arranged below the developing device 6. The laser light exposure device 5 includes a laser oscillator (not shown) and a scanning optical system 10 for scanning the laser light oscillated from the laser oscillator on the photosensitive drum 2.

On the other hand, a paper cassette 12 housing paper sheets P used as a recording material of a predetermined size is arranged in a lower portion of the apparatus body H. The paper cassette 12 is equipped with a paper feeding roller 13 for taking out the paper sheets P one by one from the paper cassette 12. A paper sheet P taken out by the paper feeding roller 13 is transferred upward along a vertical transfer path 14.

Arranged along the transfer path 14 are a pair of transfer rollers 17, a pair of aligning rollers 18, a transfer roller 16 acting as a transfer device, a fixing device 20 of a heat roll type, and a pair of paper sheet discharge rollers 21 in the order mentioned in the transfer direction of the paper sheet P.

The paper sheet P is held between the paired transfer rollers 17 for transfer of the paper sheet P. The transferred paper sheet P is stopped once by the paired aligning rollers 18 so as to correct the inclination of the paper sheet P relative to the transfer direction. Also, the tip of the paper sheet P is aligned with the tip of the toner image on the intermediate transfer belt 7 by the paired aligning rollers 18.

The transfer roller 16 is arranged to face the intermediate transfer belt 7 so as to transfer the toner image formed on the intermediate transfer belt 7 onto the paper sheet P. The fixing device 20 serves to fix the toner image transferred onto the paper sheet P to the paper sheet P. Further, the paired paper sheet discharge rollers 21 serve to discharge the paper sheet P. The paper sheet P discharged from the paired paper sheet discharge roller 21 is received by a paper sheet discharge section 23 formed on an upper portion of the apparatus body H.

The printing operation of the electrophotographic copying apparatus of the construction described above will now be described.

In the first step, the surface of the photosensitive drum 2 having the back surface of the photosensitive layer connected to the ground potential of 0 V is uniformly charged by the charging device 4 at −700 V, followed by driving the laser light exposure device 5 so as to form an electrostatic latent image on the surface of the photosensitive drum 2. In accordance with rotation of the photosensitive drum 2, the electrostatic latent image formed on the surface of the photosensitive drum 2 is positioned to face the developing device 6. Also, toner is supplied onto the electrostatic latent image in accordance with rotation of the developing roller 6a to which is applied a voltage of −300 V so as to form a toner image on the surface of the photosensitive drum 2.

The toner image formed on the surface of the photosensitive drum 2 is electrostatically transferred onto the intermediate transfer belt 7 to which is applied a voltage of +1 kV. After transfer of the toner image, the toner remaining on the surface of the photosensitive drum 2 is scraped off by the blade 9a of the drum cleaner 9.

On the other hand, a paper sheet P taken out from the paper feeding cassette 12 is transferred along the transfer path 14. To be more specific, the paper sheet P held between and transferred by the paired transfer rollers 17 is forwarded to the paired aligning rollers 18 so as to be aligned and, then, is transferred into the clearance between the intermediate transfer belt 7 and the transfer roller 16.

A voltage of +2 to 3 kV is applied to the transfer roller 16, with the result that the toner image on the intermediate transfer belt 7 is transferred onto the paper sheet P. Then, the paper sheet P having the toner image transferred thereonto is forwarded into the fixing device 20. As a result, the toner image is melted so as to be thermally fixed to the paper sheet P. In other words, a visible image is formed on the paper sheet P.

On the other hand, after transfer of the toner image noted above, the toner remaining on the intermediate transfer belt 7 is removed by the blade 11a of the belt cleaner 11. Incidentally, the toner removed by each of the drum cleaner 9 and the belt cleaner 11 is recovered by a recovery device 25 described herein later.

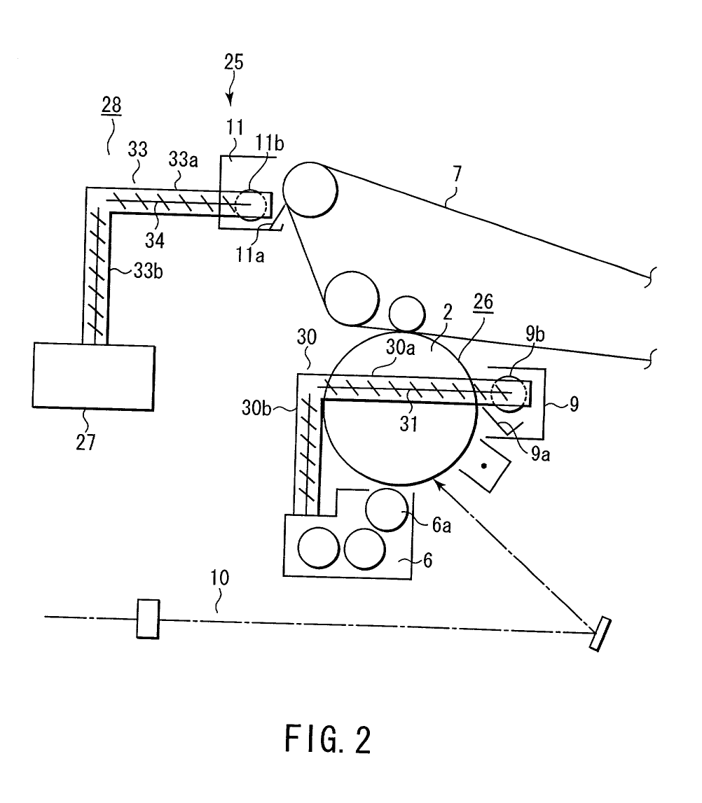

FIG. 2 shows the recovery device 25 of the toner. As shown in the drawing, the recovery device 25 includes a first recovery mechanism 26 for recovering the toner removed by the drum cleaner 9 in the developing device 6 and a second recovery mechanism 28 for recovering the toner removed by the belt cleaner 11 in a recovery container 27.

The first recovery mechanism 26 includes a duct 30 and a transfer auger 31 rotated within the duct 30. The duct 30 includes a horizontal duct portion 30a and a vertical duct portion 30b. One end portion of the horizontal duct portion 30a is connected to one side portion of the drum cleaner 9, and the lower end portion of the vertical duct portion 30b is connected to the upper surface portion of the developing device 6.

The second recovery mechanism 28 includes a duct 33 and a transfer auger 34 rotated within the duct 33. The duct 33 includes a horizontal duct portion 33a and a vertical duct portion 33b. One end portion of the horizontal duct portion 33a is connected to one side portion of the belt cleaner 11, and the lower end portion of the vertical duct portion 33b is connected to the upper surface portion of the recovery container 27.

In accordance with rotation of the discharge auger 11b, the toner removed by the belt cleaner 11 is transferred into the recovery duct 33. The toner transferred into the recovery duct 33 is further transferred in accordance with rotation of the transfer auger 34 so as to be recovered in the recovery container 27.

On the other hand, the toner removed by the drum cleaner 9 is transferred into the recovery duct 30 in accordance with rotation of the transfer auger 9b. The toner transferred into the recovery duct 30 is further transferred into the developing device 6 in accordance with rotation of the transfer auger 31 so as to be recovered for reuse.

A printing test on 100,000 paper sheets was conducted by using an electrophotographic copying apparatus of the construction described above. Table 1 shows the results.

TABLE 1

| | Image quality after | |
|---|---|---|
| | printing on 100,000 | Waste |
| | paper sheets | toner rate |
| Comparative | ◯ | 30% |
| Example 1 | | |
| Comparative | X | 0% |
| Example 2 | | |
| Example 1 | ◯ | 5% |
| Comparative | ◯ | 25% |
| Example 3 | | |

In Comparative Example 1, all the toner removed by the drum cleaner 9 and the belt cleaner 11 was recovered in the recovery container 27, and the recovered toner was not supplied into the developing device 6. In Comparative Example 2, all the toner removed by the drum cleaner 9 and the belt cleaner 11 was supplied into the developing device 6, and the removed toner was not recovered in the recovery container 27.

On the other hand, in Example 1 of the present invention, the toner removed by the drum cleaner 9 was supplied through the duct 30 into the developing device 6, and the toner removed by the belt cleaner 11 was recovered in the recovery container 27 through the duct 33 so as not to be supplied into the developing device 6. Further, in Comparative Example 3, a printing test on 100,000 paper sheets was conducted by using a copying apparatus, DP3580, manufactured by Toshiba Tec K.K. The copying apparatus used in Comparative Example 3 is of the type where the toner image is transferred directly from the photosensitive drum 2 onto the paper sheet P without using the intermediate transfer belt 7. Also, the residual toner removed by the drum cleaner 9 is recovered in the recovery container 27 and is not supplied into the developing device 6.

In Comparative Example 1, a good image was obtained even after printing on 100,000 paper sheets. However, about 30% of the toner used was discarded as waste toner. In Comparative Example 2, it was possible to utilize all the residual toner removed by the drum cleaner 9 and the belt cleaner 11. However, image defects were generated due to the defective formation of the developing layer caused by paper fibers and fogging caused by the deterioration in the charging properties of the developing agent. In Comparative Example 3, a good image was formed even after printing on 100,000 paper sheets. However, about 25% of the toner used was discarded as waste toner.

On the other hand, the waste toner rate was very low, i.e., 5%, in Example 1 of the present invention. In addition, a good image was obtained even after printing on 100,000 paper sheets. It should be noted in this connection that, in Example 1, the paper fiber, the additives, or the various kinds of foreign matter transferred via the paper sheet are certainly attached to the intermediate transfer belt 7. However, this foreign matter is removed by the belt cleaner 11 so as to prevent the foreign matter from being attached to the photosensitive drum 2, leading to the excellent experimental data given in Table 1.

The potential on the surface of the photosensitive drum 2 is changed by the ambient temperature, the ambient humidity, and the degree of use of the photosensitive drum 2, making it difficult to establish stable transfer conditions. However, the particular problem is not generated in the transfer of the toner image from the intermediate transfer belt 7 onto the paper sheet P so as to make it possible to achieve the transfer of the toner image while suppressing the amount of residual toner.

Also, it is possible to select an elastic body such as rubber or sponge and a flexible material such as a belt for forming the secondary transfer section of the intermediate transfer body so as to make it possible to easily achieve satisfactory contact between the intermediate transfer body and the recording paper sheet and to increase the nip width. As a result, it is possible to achieve transfer of the toner image onto the recording paper sheet while suppressing the amount of the residual toner, compared with the primary transfer section or toner image transfer from the photosensitive body directly onto the recording paper sheet in the general apparatus. Such being the situation, a satisfactory result, i.e., 5% of the waste toner rate, can be obtained in Example 1 of the present invention.

It should also be noted that the cleaning mechanism in the drum cleaner 9 and the belt cleaner 11 is not limited to a blade formed of a plate-like elastic body. It is also possible to use a rotary brush or a stationary brush as the cleaning mechanism in place of the blade formed of a plate-like elastic body.

Also, in the embodiment described above, the residual toner removed by the belt cleaner 11 is recovered in the recovery container 27. Alternatively, it is also possible for the belt cleaner 11 or the support body thereof to be constructed to act as the recovery container.

As described above, in the image forming apparatus of the present invention, the residual toner after the primary transfer of the toner image from the photosensitive drum 2 onto the intermediate transfer belt 7 is recovered in the developing device 6. On the other hand, the residual toner after the secondary transfer of the toner image from the intermediate transfer belt 7 onto the paper sheet P is discarded as waste toner. The particular construction of the present invention makes it possible to prolong the life of the developing device 6 and the life of the developing agent and to decrease the amount of waste toner.

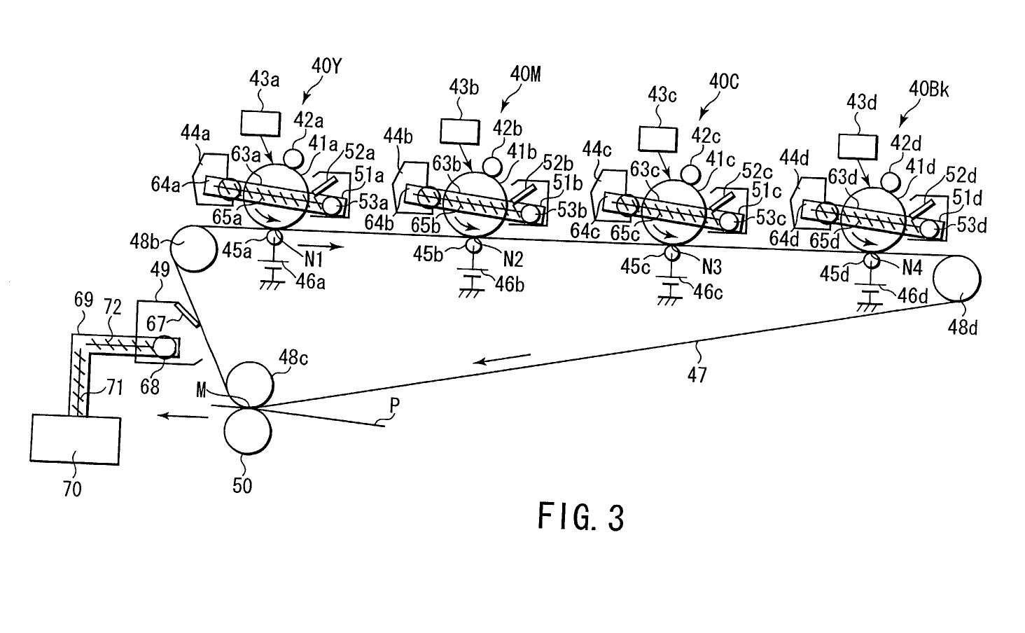

FIG. 3 shows the construction of a color electrophotographic copying apparatus according to a second embodiment of the present invention. As shown in the drawing, the color electrophotographic copying apparatus of the present invention comprises four image forming sections including an image forming section 40Y for forming a yellow image, an image forming section 40M for forming a magenta image, an image forming section 40C for forming a cyan image, and an image forming section 40Bk for forming a black image.

Photosensitive drums 41a, 41b, 41c and 41d used as image carriers are arranged in the image forming sections 40Y, 40M, 40C and 40Bk, respectively. Arranged around the photosensitive drum 41a are a charging roller 42a, a light exposure section 43a, a developing device 44a and a drum cleaner 51a acting as a first removing device. Arranged around the photosensitive drum 41b are a charging roller 42b, a light exposure section 43b, a developing device 44b and a drum cleaner 51b acting as a first removing device. Arranged around the photosensitive drum 41c are a charging roller 42c, a light exposure section 43c, a developing device 44c and a drum cleaner 51c acting as a first removing device. Further, arranged around the photosensitive drum 41d are a charging roller 42d, a light exposure section 43d, a developing device 44d and a drum cleaner 51d acting as a first removing device. A yellow toner, a magenta toner, a cyan toner and a black toner are housed in the developing devices 44a, 44b, 44c and 44d, respectively.

Each of the photosensitive drums 41a, 41b, 41c and 41d is formed of an organic photosensitive body that is negatively charged in this embodiment and includes a drum body (not shown) made of, for example, aluminum and a photoconductive layer (not shown) formed on the drum body. Each of these photosensitive drums is rotated at a predetermined process speed in the direction denoted by an arrow by a driving device (not shown).

A blade 52a and a transfer auger 53a are arranged inside the drum cleaner 51a, and the drum cleaner 51a is connected to a developing device 44a through a first recovery device 63a. A blade 52b and a transfer auger 53b are arranged inside the drum cleaner 51b, and the drum cleaner 51b is connected to a developing device 44b through a first recovery device 63b. A blade 52c and a transfer auger 53c are arranged inside the drum cleaner 51c, and the drum cleaner 51c is connected to a developing device 44c through a first recovery device 63c. Further, a blade 52d and a transfer auger 53d are arranged inside the drum cleaner 51d, and the drum cleaner 51d is connected to a developing device 44d through a first recovery device 63d. The first recovery device 63a includes a duct 64a connecting the side surfaces of the drum cleaner 51a and the developing device 44a and a transfer auger 65a arranged within the duct 64a. Likewise, the first recovery device 63b includes a duct 64b connecting the side surfaces of the drum cleaner 51b and the developing device 44b and a transfer auger 65b arranged within the duct 64b. The first recovery device 63c includes a duct 64c connecting the side surfaces of the drum cleaner 51c and the developing device 44c and a transfer auger 65c arranged within the duct 64c. Further, the first recovery device 63d includes a duct 64d connecting the side surfaces of the drum cleaner 51d and the developing device 44d and a transfer auger 65d arranged within the duct 64d.

An intermediate transfer belt 47 acting as an endless intermediate transfer body abuts the photosensitive drums 41a, 41b, 41c and 41d at primary transfer nip portions N1, N2, N3 and N4, respectively. The intermediate transfer belt 47 is stretched along a driving roller 48a, a tension roller 48b and a roller 48c arranged to face a secondary transfer roller 50 and is rotated in the direction denoted by an arrow by the driving of the driving roller 48a.

A transfer roller 45a is arranged to abut the photosensitive drum 41a with the intermediate transfer belt 47 interposed therebetween at the primary transfer nip portion N1. Likewise, a transfer roller 45b is arranged to abut the photosensitive drum 41b with the intermediate transfer belt 47 interposed therebetween at the primary transfer nip portion N2. A transfer roller 45c is arranged to abut the photosensitive drum 41c with the intermediate transfer belt 47 interposed therebetween at the primary transfer nip portion N3. Further, a transfer roller 45d is arranged to abut the photosensitive drum 41d with the intermediate transfer belt 47 interposed therebetween at the primary transfer nip portion N4. The transfer rollers 45a, 45b, 45c and 45d are connected to primary transfer bias power sources 46a, 46b, 46c and 46d, respectively. The roller 48c is arranged to abut the secondary transfer roller 50 with the intermediate transfer belt 47 interposed therebetween so as to form a secondary transfer nip portion M. The secondary transfer roller 50 is arranged to be movable away from the intermediate transfer belt 47.

A belt cleaner 49 acting as a second removing device for removing the residual toner remaining on the surface of the intermediate transfer belt 47 after transfer of the toner image from the intermediate transfer belt 47 onto the paper sheet P is arranged outside the intermediate transfer belt 47 downstream of the secondary transfer nip portion M in the running direction of the intermediate transfer belt 47.

A blade 67 and a transfer auger 68 are arranged inside the belt cleaner 49, and the belt cleaner 49 is connected to a recovery container 70 through a second recovery device 69. The second recovery device 69 includes a duct 71 connecting the side surface section of the belt cleaner 49 to the upper surface portion of the recovery container 70 and a transfer auger 72 arranged within the duct 71.

The image forming operation of the color electrophotographic copying apparatus of the construction described above will now be described.

In the first step, the transfer material P is taken up one sheet at a time and transferred to a resist roller (not shown) upon generation of a signal for starting up the image forming operation. In this step, rotation of the resist roller is stopped so that the tip portion of the transfer material P is in the waiting position immediately before the secondary transfer nip portion M. Then, the resist roller starts its rotation in accordance with the timing of the start-up of the image formatting operation performed by each of the image forming sections 40Y, 40M, 40C and 40Bk.

On the other hand, upon generation of a signal for starting up the image forming operation, the surfaces of the photosensitive drums 41a, 41b, 41c and 41d, which are driven at a predetermined process speed, are uniformly charged negative by the charging rollers 42a, 42b, 42c and 42d, respectively. Then, the input image signals are converted into optical signals in the light exposure devices 43a, 43b, 43c and 43d, and the converted laser beams are scanned on the photosensitive drums 41a, 41b, 41c and 41d, respectively, so as to form electrostatic latent images. Further, a yellow toner is supplied by the developing device 44a, to which is applied a developing bias of the same polarity as the charge polarity (negative) on the surface of the photosensitive drum 41a, onto the electrostatic latent image formed on the photosensitive drum 41a so as to form a yellow toner image. The yellow toner image thus formed is transferred onto the intermediate transfer belt 47 by the transfer roller 45a, to which is applied a primary transfer bias (positive bias) opposite in polarity to the toner, in the primary transfer nip portion N1.

That portion of the intermediate transfer belt 47 onto which the yellow toner image was transferred is moved to reach the image forming section 40M. As a result, the magenta toner image formed on the surface of the photosensitive drum 41b is transferred onto the intermediate transfer belt 47 in the primary transfer nip portion N2 such that the magenta toner image is superposed on the yellow toner image formed previously on the intermediate transfer belt 47.

Likewise, the cyan toner image and the black toner image formed on the surfaces of the photosensitive drums 41c and 41d of the image forming sections 40C and 40D are successively superposed in the primary transfer nip portions N3 and N4, respectively, onto the superposed yellow and magenta toner images transferred onto the intermediate transfer belt 47, with the result that a full-color toner image is formed on the intermediate transfer belt 47.

Then, the transfer material P is transferred to the secondary transfer nip portion M by a resist roller (not shown) in accordance with the timing at which the tip portion of the full-color toner image formed on the intermediate transfer belt 47 is transferred to the secondary transfer nip portion M. Then, the full-color toner image is collectively transferred onto the transfer material P by the secondary transfer roller 50 to which is applied a secondary transfer bias (positive bias) opposite in polarity to the toner. The transfer material P having the full-color toner image transferred there onto is transferred to a fixing device (not shown) so as to be heated and pressurized. As a result, the full-color toner image is thermally fixed to the surface of the transfer material P, and the transfer material P having the full-color toner image fixed thereto is discharged to the outside.

On the other hand, the residual toners remaining on the surfaces of the photosensitive drums 41a, 41b, 41c and 41d after the primary transfer of the toner image onto the intermediate transfer belt 47 are removed by the blades 52a, 52b, 52c and 52d of the drum cleaners 51a, 51b, 51c and 51d, respectively. The removed toners are transferred by the transfer augers 53a, 53b, 53c, 53d into the ducts 64a, 64b, 64c, 64d, respectively. The toners transferred into the ducts 64a, 64b, 64c, 64d are further transferred by the transfer augers 65a, 65b, 65c, 65d so as to be recovered and supplied into the developing devices 44a, 44b, 44c and 44d, respectively.

The residual toner remaining on the intermediate transfer belt 47 after the secondary transfer of the full-color toner image onto the transfer material P is removed by the blade 67 of the belt cleaner 49. The toner thus removed is transferred by the transfer auger 68 into the duct 69. Further, the toner transferred into the duct 69 is transferred by the transfer auger 72 so as to be recovered in the recovery device 70.

The second embodiment of the present invention described above produces a function and effect similar to those produced by the first embodiment described previously.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus, comprising:
an image forming device which forms an electrostatic latent image on an image carrier;
a developing device which supplies a developing agent onto the electrostatic latent image formed by said image forming device so as to form a developing agent image;
an intermediate transfer body onto which the developing agent image formed by said developing device is temporarily transferred;
a first removing device which removes the developing agent remaining on said image carrier after transfer of the developing agent image onto said intermediate transfer body;
a transfer device which transfers the developing agent image transferred onto said intermediate transfer body onto a recording material;
a second removing device which removes as waste developing agent the developing agent remaining on said intermediate transfer body after transfer of the developing agent image performed by said transfer device;
a first recovery device which recovers the developing agent removed by said first removing device into said developing device; and
a second recovery device which recovers the developing agent removed by said second removing device into a recovery section.

2. An image forming apparatus according to claim 1, wherein said residual developing agent is removed by a plate-like elastic body or a brush-like member in each of said first and second removing devices.

3. An image forming apparatus according to claim 1, wherein said first recovery device includes a first duct connecting said first removing device to said developing device and a first transfer mechanism arranged within said first duct for transferring the developing agent.

4. An image forming apparatus according to claim 3, wherein said second recovery device includes a second duct which connects said second removing device to said recovery section and a second transfer mechanism which is arranged within said second duct and which transfers the developing agent.

5. An image forming apparatus according to claim 1, wherein said second recovery device includes a second duct which connects said second removing device to said recovery section and a second transfer mechanism which is arranged within said second duct and which transfers the developing agent.

6. An image forming apparatus according to claim 1, wherein said developing device is arranged below said second removing device.

7. An image forming apparatus according to claim 1, wherein said developing device houses a developing agent of a single color.

8. An image forming apparatus, comprising:
a plurality of image forming devices which form a plurality of electrostatic latent images on a plurality of image carriers;
a plurality of developing devices which supply developing agents of different colors onto the electrostatic latent images formed by said image forming devices so as to form developing agent images;
an intermediate transfer body onto which the developing agent images formed by said developing devices are temporarily transferred in a superposed fashion;
a plurality of first removing devices which remove the developing agent remaining on each of the image carriers after transfer of the developing agent image onto said intermediate transfer body;
a transfer device which transfers the developing agent image transferred onto said intermediate transfer body onto a recording material;
a second removing device which removes as waste developing agent the developing agent remaining on said intermediate transfer body after transfer of the developing agent image performed by said transfer device;
a first recovery device which recovers the developing agent removed by said plural first removing devices into said plural developing devices; and
a second recovery device which recovers the developing agent removed by said second removing device into a recovery section.

9. An image forming apparatus according to claim 8, wherein said residual developing agent is removed by a plate-like elastic body or a brush-like member in each of said first and second removing devices.

10. An image forming apparatus according to claim 8, wherein said first recovery device includes a first duct which connects said first removing device to said developing device and a first transfer mechanism which is arranged within said first duct and which transfers the developing agent.

11. An image forming apparatus according to claim 10, wherein said second recovery device includes a second duct which connects said second removing device to said recovery section and a second transfer mechanism which is arranged within said second duct and which transfers the developing agent.

12. An image forming apparatus according to claim 8, wherein said second recovery device includes a second duct which connects said second removing device to said recovery section and a second transfer mechanism which is arranged within said second duct and which transfers the developing agent.

13. An image forming apparatus according to claim 8, wherein said developing device is arranged below said second removing device.
